(19) United States
(12) Patent Application Publication
(10) Pub. No.: US 2009/0116168 A1
(43) Pub. Date: May 7, 2009

(54) Electric multilayer component and method for the production of a multilayer component

(76) Inventors: Christian Block, Stainz (AT); Gunter Engel, Leibnitz (AT); Thomas Feichtinger, Graz (AT); Volker Wischnat, Frauental (AT)

Correspondence Address: FISH & RICHARDSON PC, P.O. BOX 1022, MINNEAPOLIS, MN, 55440-1022, US

(21) Appl. No.: 11/911,280

(22) PCT Filed: Apr. 11, 2006
(86) PCT No.: PCT/DE06/00640

§ 371 Date: May 8, 2008

(30) Foreign Application Priority Data
Apr. 11, 2005 (DE) 10 2005 016 590.7

(51) Int. Cl. H01G 4/228; H01G 7/00

(52) U.S. Cl. 361/306.3; 361/309; 29/25.42

(57) ABSTRACT

An electrical multiple-layer component is described herein. The component includes a base body having dielectric layers and internal electrodes. The internal electrodes are of connected to each other electrically between the dielectric layers via at least one external electrode on side surfaces of the base body. The component also includes an electrical connection between the external electrode and a contact surface on a surface of the base body and insulated relative to an outer side of the component.

An electrical multiple-layer component will be described. In addition, a method for producing a multiple-layer component will be specified.

A multiple-layer component with a functional unit integrated into a base body is known, for example, from the publication DE 103 13 891 A1. A method for producing a multiple-layer component is known from the publication DE 103 17 596 A1.

A task to be achieved consists in specifying a multiple-layer component with an advantageous contacting of the functional unit of the component. Another task to be achieved consists in specifying a method for producing such a multiple-layer component.

An electrical multiple-layer component will be specified comprising a base body with dielectric layers and structured metal layers which are arranged between them and in which internal electrodes are formed that are connected to each other electrically via external electrodes arranged on side surfaces of the base body.

In a first preferred variant, an electrical connection between an external electrode and a contact surface arranged on a main surface of the base body is insulated relative to the outer side of the component, e.g., by means of an insulating layer covering this connection. This insulating layer is optionally a component of the terminally positioned dielectric layer of the base body.

In a second preferred variant, at least one of the internal electrodes contacts a contact surface of the component by means of a through-hole contact. Preferably, a first internal electrode turned towards the contact surface is connected to this contact surface by means of the through-hole contact.

At least one other contact surface, which is connected by means of a through-hole contact to a second internal electrode that is turned towards this contact surface and is electrically isolated from the first internal electrode, can be arranged on the bottom side of the base body.

In a third preferred variant, a terminally positioned first internal electrode connected to a first external electrode and a terminally positioned second internal electrode connected to a second external electrode are constructed in one and the same plane, and each contacts a contact surface of the component by means of a through-hole contact.

The features of the first, second, and third preferred variant can be combined with each other arbitrarily.

The multiple-layer component and also its advantageous constructions will be explained in more detail below.

The dielectric layers and the metal layers are arranged alternately one above the other. The dielectric layers are preferably made from a ceramic material.

A connection of the component, that is, an exposed solderable surface arranged on the surface of the base body, is designated as a contact surface. The contact surface is preferably arranged on the bottom side of the base body, but alternatively can also be arranged on its top side. The contact surface is preferably a galvanically reinforced metal surface. The contact surfaces preferably have a Ball-Grid Array (BGA) or Land-Grid Array (LGA).

An external electrode is arranged on a side surface, that is, on a lateral surface of the base body. An external electrode usually consists of a baked metal paste, which is solderable only to a limited degree or not at all—in contrast, for example, with a contact surface. The external electrodes can be provided, e.g., with a solderable coating for improving the solderability. In one variant, however, this can be left out.

Opposite pole internal electrodes are designated as first and second internal electrodes. The internal electrodes and the dielectric layers arranged between these form a stack. The internal electrode contacted by the through-hole contact is preferably a terminally positioned internal electrode of this stack.

The multiple-layer component is preferably a multiple-layer capacitor. Opposite pole internal electrodes arranged one above the other, i.e., connected to different external electrodes, and the dielectric layers arranged between these form a capacitor stack. In the base body, several capacitor stacks can be arranged one next to the other, wherein different capacitor stacks can preferably be contacted via different contact surfaces.

The multiple-layer component, however, can also be a multiple-layer varistor. Here, a first stack is preferably formed by first internal electrodes connected to a first external electrode and a second stack is formed by second internal electrodes connected to a second external electrode. The stacks are arranged side by side. A first and a second internal electrode, which are formed in a metal layer, lie one next to the other.

There is an electrical connection between the contact surface and the external electrode, which, however, is preferably hidden. The contact surface is preferably connected electrically to an associated external electrode exclusively via an electrical connection hidden in the base body.

The electrical connection is formed in one variant by the through-hole contact and the internal electrode connected to this contact. In this case, the electrical connection between a contact surface and the external electrode is buried in the base body.

In another variant, the external electrode arranged on one side surface of the base body can be connected electrically to an electrically conductive layer arranged on the bottom side of the base body, wherein a part of this electrically conductive layer is provided as a contact surface. Another part of this electrically conductive layer provided as an electrical connection between the contact surface and the external electrode is covered, preferably completely, with an insulating layer (passivation layer) relative to the surface of the component.

In one variant, a terminally positioned first internal electrode and a terminally positioned second internal electrode are formed in one plane and each contacts the contact surface by means of a through-hole contact. A terminally positioned internal electrode and an internal electrode following in the stack are preferably each connected electrically to the same external electrode.

A first terminally positioned dielectric layer of the base body, through which the through-hole contact is guided, has in one variant a greater thickness than the thickness of the dielectric layers in the capacitor stack or in the varistor stack. Also, a second terminally positioned dielectric layer facing away from the first terminally positioned dielectric layer can be thicker than the dielectric layers in the capacitor stack or in the varistor stack.

The first and/or second terminally positioned dielectric layer can be formed from several sublayers arranged one above the other. The sublayers are identical in terms of material and thickness in one variant. The sublayers, however, can also vary in terms of material and/or thickness.

The dielectric layers suitable for forming a capacitor stack can be made from, e.g., the following materials: COG, X7R, Z5U, Y5V, HQM. The dielectric layers suitable for forming a varistor stack can be made from, e.g., a varistor ceramic ZnO—Bi or ZnO—Pr.

The internal electrodes and/or external electrodes can contain Ni, Cu, Ag, Pd, and/or Pt or can be made from the named metals. The internal electrodes can also contain metal alloys, e.g., AgPd or AgPt. The through-hole contacts are preferably made from the same material as the internal electrodes.

The LGA or BGA solder balls can be made from Sn, SnAg, SnAgCu, SnPb, or Au, or can contain the named materials.

The contact surfaces, which are used for solder balls as UBM (Under-Bump Metallization), are preferably formed from several layers. As the base layer, i.e., the bottommost layer, e.g., Ag, AgPt, AgPd, or Cu can be used. A masking layer, e.g., made from Ni, can be arranged on the base layer. Preferably an oxidation protective layer, e.g., made from Au or Pd, is arranged on the masking layer. In principle, however, the contact surfaces can be made from a layer preferably containing a silver alloy.

In addition, a first method for producing a multiple-layer component will be specified. The method comprises the following steps:

A) creating a first terminally positioned dielectric layer with electrical through-hole contacts,

B) creating electrically conductive layers contacting the through-hole contacts on both sides of the first terminally positioned dielectric layer,

C) creating a multiple-layer body comprising several component areas, wherein a layer sequence of dielectric layers and metal layers arranged one above the other is created on the first terminally positioned dielectric layer,

D) separating component areas,

E) metallizing side surfaces of a component area for forming external electrodes of the component.

In addition, a second method for producing a multiple-layer component will be specified. The method comprises the following steps:

A) creating a first terminally positioned dielectric layer with electrical through-hole contacts,

B) creating electrically conductive layers contacting the through-hole contacts on both sides of the first terminally positioned dielectric layer,

C) creating a multiple-layer body comprising several component areas, wherein a layer sequence of dielectric layers and metal layers arranged one above the other is created on the first terminally positioned dielectric layer,

D) superimposing the multiple-layer body onto a carrier and separating component areas, wherein the arrangement of component areas on the carrier is maintained,

E) filling intermediate spaces formed between the adjacent component regions with an electrically conductive paste and baking this paste,

F) separating component areas along the intermediate spaces for forming components.

Advantageous constructions of the first and second methods are explained below.

The multiple-layer body to be generated in step C) is preferably generated by pressing, decarburization, and sintering of a body that comprises the terminally positioned dielectric layer and the layer sequence. This is especially the case for a multiple-layer body made from a ceramic material.

The electrically layers arranged on the exposed surface of the first terminally positioned dielectric layer are preferably printed with bumps before step F).

The electrically conductive layers arranged on the exposed surface of the first terminally positioned dielectric layer are preferably provided for forming contact surfaces of the component allowing surface mounting.

Areas provided at least as a contact surface for the electrically conductive layers arranged on the exposed surface of the first terminally positioned dielectric layer are preferably thickened galvanically with a solderable material.

An insulating layer can be deposited on one part of an electrically conductive layer that electrically connects an area of this electrically conductive layer provided as a contact surface with an external electrode.

A second terminally positioned dielectric layer of the multiple-layer body facing away from the first terminally positioned dielectric layer can be formed from several sublayers arranged one above the other.

In one variant of the method, the first terminally positioned dielectric layer is formed from several sublayers arranged one above the other.

A part of the multiple-layer body with the component areas can be surrounded in one variant of the second method by an edge region that is free from hidden component structures and is separated after step C) from component areas by intermediate spaces to be filled in step E) with the electrically conductive paste, wherein the arrangement of component areas and the edge area on the carrier is maintained, and wherein the edge area is in step F) separated along the intermediate spaces from component areas.

The multiple-layer component and the processing steps will be explained below with reference to schematic figures that are not true to scale. Shown are:

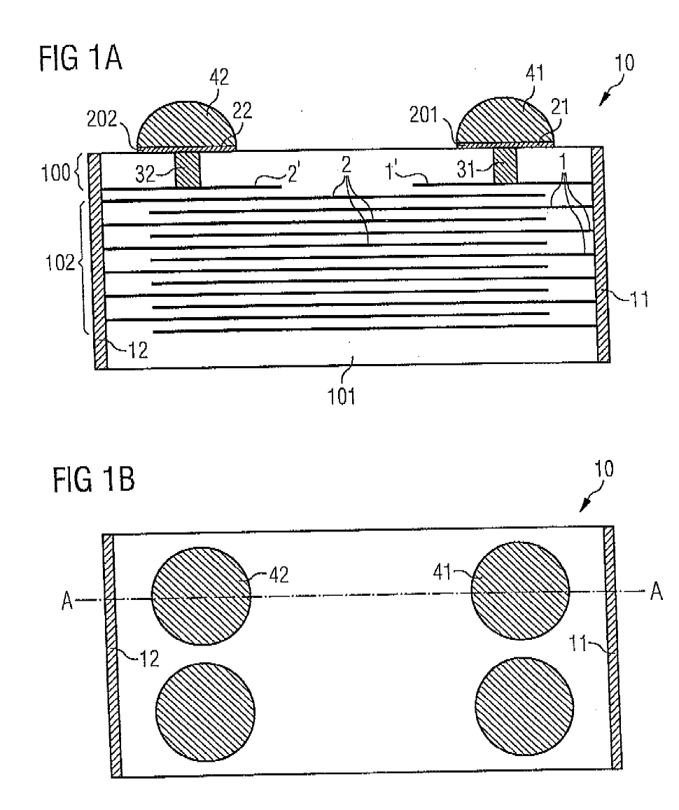

FIG. 1A, in cross section, a multiple-layer component with internal electrodes that are connected electrically to each other by means of an external electrode and to a contact surface by means of through-hole contacts;

FIG. 1B, a plan view onto the bottom side of the component according to FIG. 1A;

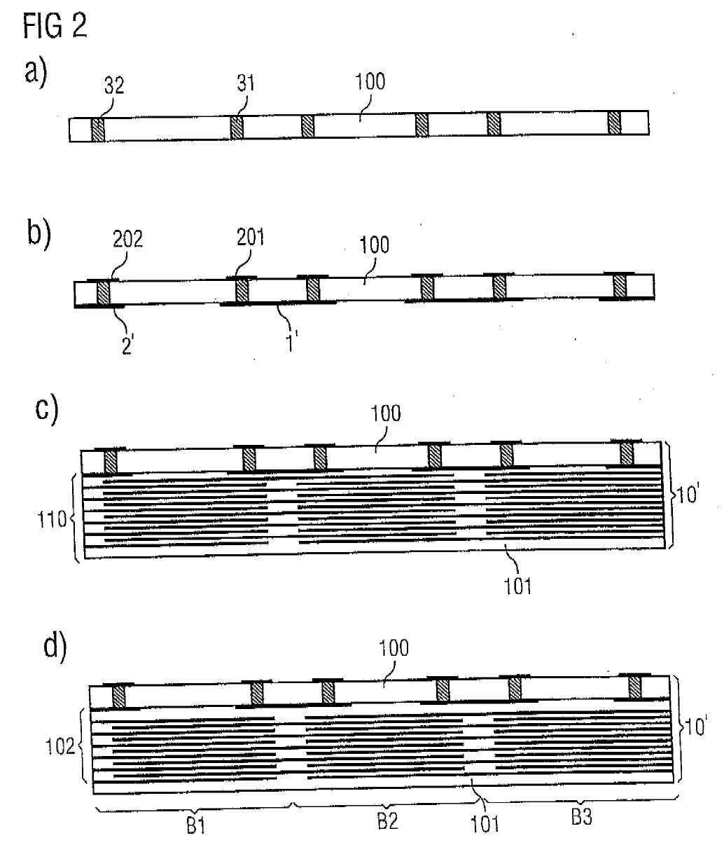

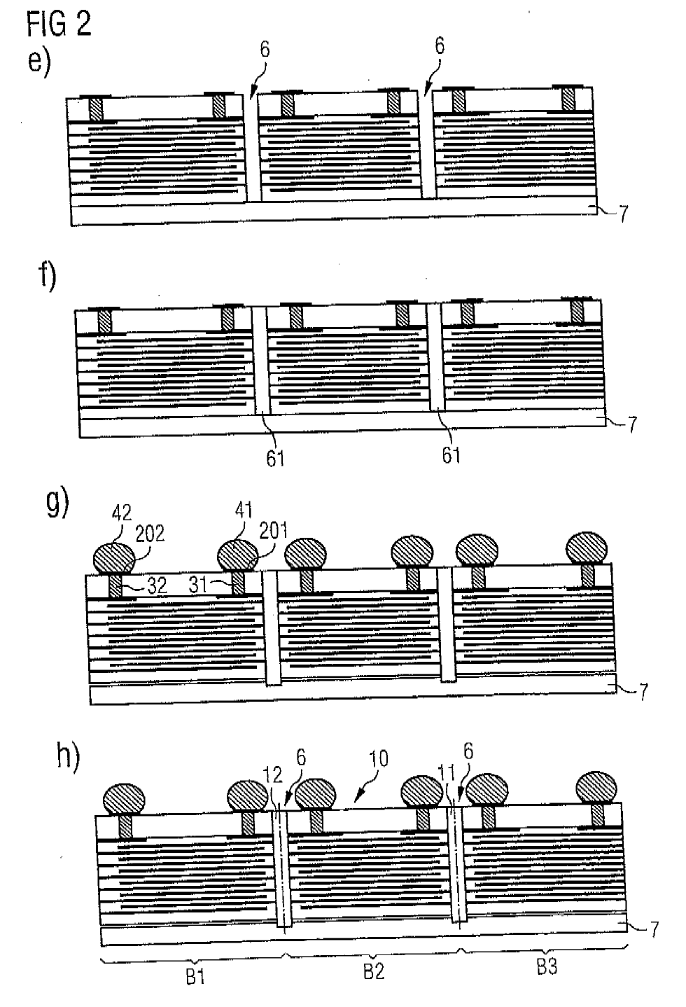

FIG. 2, processing steps of a method for producing a component according to FIG. 1A;

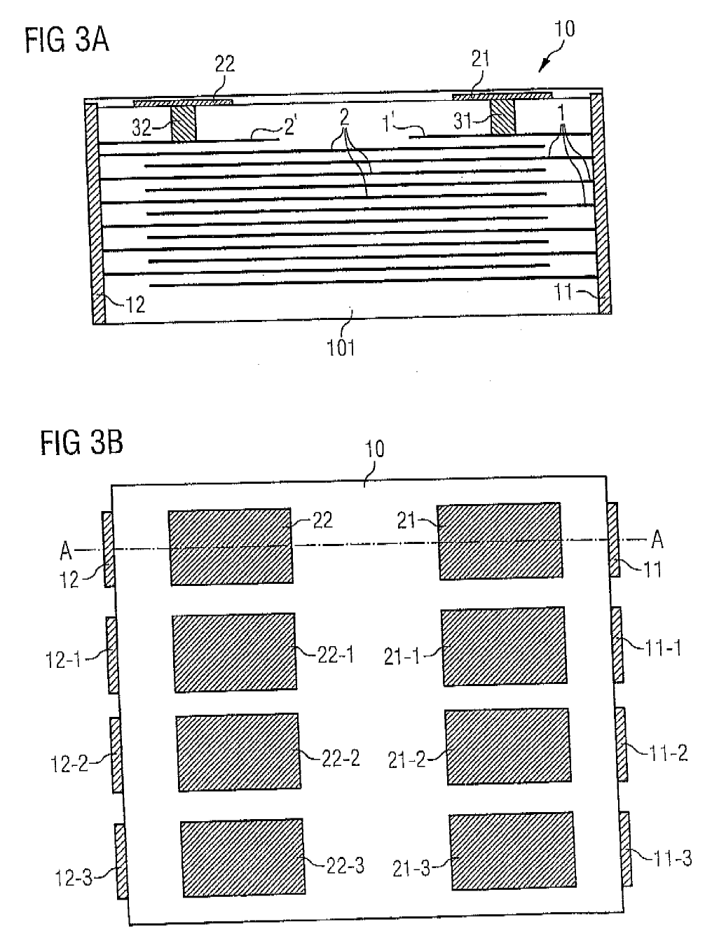

FIG. 3A, in cross section, a multiple-layer component with several capacitor stacks that can be contacted independently of each other;

FIG. 3B, a plan view onto the bottom side of the component according to FIG. 3A;

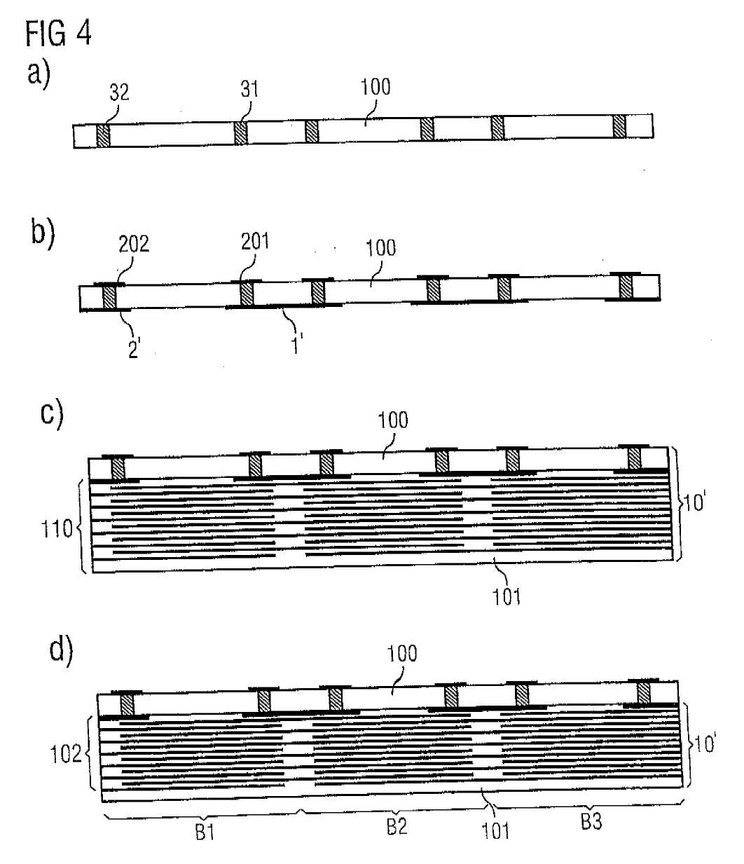

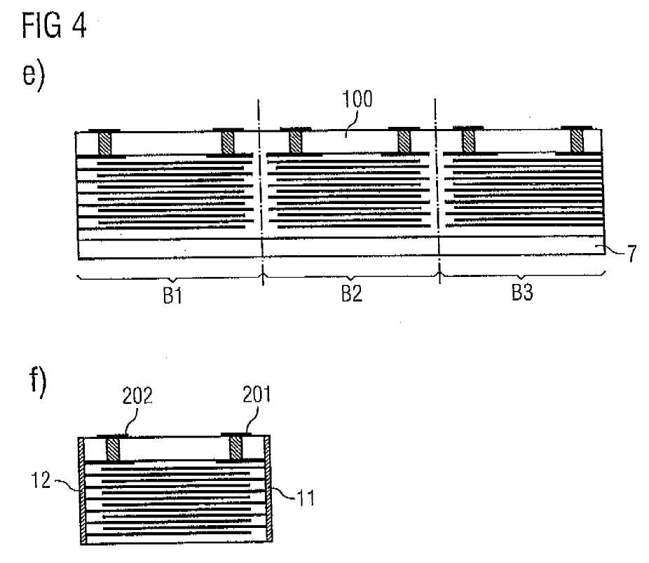

FIG. 4, processing steps of a method for producing a component according to FIG. 1A or 3A;

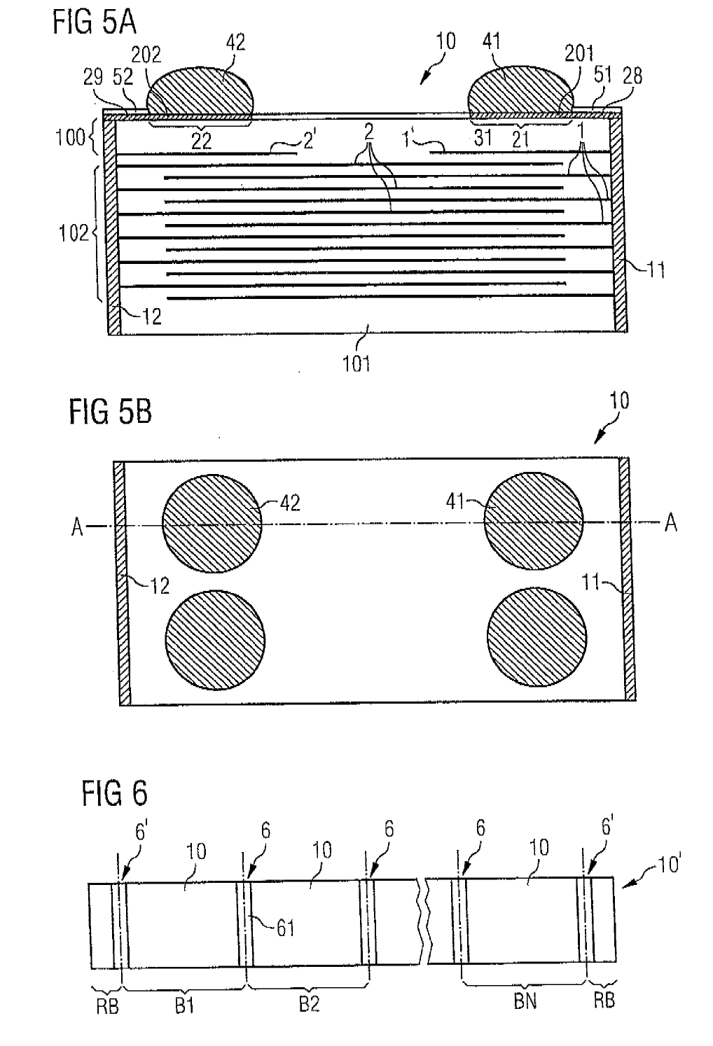

FIG. 5A, in cross section, a multiple-layer component in which an external electrode is connected electrically to an electrically conductive layer with a contact surface, wherein a part of the electrically conductive layer is covered with a passivation layer;

FIG. 5B, a plan view onto the bottom side of the component according to FIG. 5A;

FIG. 6, a multiple-layer body that comprises edge areas that are different from the component areas.

The bottom side of the multiple-layer component shown in FIGS. 1A, 3A, and 5A points upward.

In FIGS. 1A and 1B, a multiple-layer component with a base body 10 is shown that comprises dielectric layers and intermediate metal layers. FIG. 1A corresponds to a section along a line AA shown in FIG. 1B. This also applies for the FIGS. 3A and 3B or 5A and 5B.

The metal layers are each structured in FIG. 1A to form at least one internal electrode. First internal electrodes 1, 1′ are connected to a first external electrode 11 and second internal electrodes 2, 2′ are connected to a second external electrode 12. The external electrodes are arranged on opposing side surfaces of the base body. The first and second internal electrodes 1, 2 are arranged alternately one above the other and form a capacitor stack 102 together with the dielectric layers arranged between them.

The terminally positioned first internal electrode 1′ and the terminally positioned second internal electrode 2′ are arranged in a metal layer. These internal electrodes are each contacted by means of a through-hole contact 31, 32 to an electrically conductive layer 201, 202 forming the contact surface 21, 22 in this variant. The contact surfaces 21, 22 are equipped with bumps—in this example, BGA bumps.

The first terminally positioned dielectric layer 100 is created as a first layer of the base body 10, see FIGS. 2a to 2c. This layer has a greater thickness than the dielectric layers arranged between the internal electrodes 1, 2.

The second terminally positioned dielectric layer 101 also has a greater thickness than the dielectric layers of the capacitor stack 102.

The contact surfaces 21, 22 in FIG. 1B are formed with a round shape, because they are to be provided with BGA bumps.

In FIGS. 3A, 3B, a variant of the multiple-layer component explained in FIGS. 1A, 1B is shown which comprises several functional units that can be contacted independently, four capacitor stacks in the shown example. Different functional units have different pairs of external electrodes 11, 12; 11-1, 12-1; 11-2, 12-2; 11-3, 12-3 and are connected to different pairs of contact surfaces 21, 22; 21-1, 22-1; 21-2, 22-2; 21-3, 22-3. The contact surfaces have a rectangular construction in this embodiment, and can be provided with LGA bumps.

In FIGS. 2 and 4, different methods for producing a multiple-layer component according to FIG. 1A, 1B or 3A, 3B are presented. In FIGS. 2a to 2d and 4a to 4d, processing steps are shown for preparing a sintered multiple-layer body 10′ comprising several component areas B1, B2, B3. The component areas B1, B2, B3 are precursor components for the component to be produced.

In FIG. 2a, a first terminally positioned dielectric layer 100 is shown in which holes for forming through-hole contacts 31, 32 are stamped and filled with an electrically conductive paste. On both sides of the layer 100, electrically conductive layers 201, 202, 1′, 2′ contacting the through-hole contacts are created (FIG. 2b), wherein the electrically conductive layers 201 and 1′ and also 202 and 2′ are connected to each other by means of the through-hole contacts 31, 32. On one side of this layer, electrically conductive layers 201, 202 are created that are provided as contact surfaces. On the opposite side of this layer, electrically conductive layers 1′ and 2′ are created that are used as terminally positioned internal electrodes and are connected to the external electrodes in a later processing step.

On the terminally positioned dielectric layer 100, a layer sequence 110 is created, wherein dielectric layers—preferably ceramic-bearing layers—are laminated in alternating sequence with metal layers. The layer and the layer sequence 110 together form a multiple-layer body 10′. It is advantageous for the terminally positioned dielectric layer 101 of the multiple layer body to have a thicker construction than the inner dielectric layers, e.g., sublaying several dielectric sublayers one above the other. These sublayers are preferably identical to the inner dielectric layers.

In this way, the layer 100 can also be formed from several sublayers. However, it is also possible to form the layer 100 and/or the layer 101 each as an individual layer with a greater thickness.

The multiple-layer body 10′ is pressed (FIG. 2d), decarburized, and sintered. The sintered multiple-layer body 10′ is applied to a carrier 7 and preferably fixed to its surface through adhesive forces.

The multiple-layer body 10′ comprises several areas B1, B2, B3 provided as component areas, which are separated from each other, e.g., by means of saws, wherein intermediate spaces 6 are created between the component areas (FIG. 2e). The carrier 7 can here be sawed, but remains in one piece, wherein the arrangement of the component areas on the carrier is also essentially maintained. In the step shown in FIG. 2f, the intermediate spaces 6 are filled with an electrically conductive material 61, e.g., a metal paste, which is then baked. An intermediate space 6 has the shape of a channel that separates two rows of component areas from each other.

Bumps 41, 42 are deposited on the electrically conductive layers 201, 202 provided as contact surfaces (FIG. 2g). The component areas B1, B2, B3 of the multiple-layer body 10′ are separated in the step shown in FIG. 2h along the imaginary lines (saw lines) shown as dashed lines in the figure, wherein components with external electrodes 11, 12 on their side surfaces are formed. These lines pass approximately through the center of the intermediate spaces 6.

The electrically conductive layers 201, 202, 1′, 2′, 1, 2 of the metal layers are preferably generated in a screen-printing process. The electrically conductive layers 201, 202 provided as contact surfaces are preferably thickened galvanically after the sintering of the multiple-layer body 10′.

Processing steps of another method are shown schematically in FIG. 4.

The processing steps shown in FIGS. 4a to 4d for creating a multiple-layer body 10′ match the processing steps already explained in FIGS. 2a to 2d.

Component areas B1, B2, B3 are separated, e.g., by sawing along the separating lines indicated with dashed lines after the preparation of the multiple-layer body 10′, and the side surfaces of each component area are metallized, i.e., covered with a metal paste that will be baked, for forming external electrodes 11, 12 of the component.

It is advantageous to arrange the multiple-layer body 10′ on a carrier 7 for the separation of the component areas, wherein after separation the component areas are detached from the carrier.

In the variants shown in FIGS. 5A and 5B, the external electrode 11, 12 arranged on a side surface of the base body 10 projects past an edge of this side surface and forms an electrically conductive layer 201, 202 on the bottom side of the base body 10. A part of this electrically conductive layer is provided as a contact surface 21, 22. Preferably, only this area of the electrically conductive layer is exposed or uncovered by the insulating layer 52. The other part of this electrically conductive layer provided as an electrical connection 28, 29 between the contact surface and the side external electrode 11, 12 is in this example completely covered at the surface of the component with the insulating layer 52 (passivation layer).

The contact surfaces 21, 22 are equipped with bumps 41, 42. The insulating layer 52 is used as a solder stop when melting the bumps 41, 42.

FIG. 6 shows a variant in which a part of the multiple-layer body having the component areas B1, B2, B3 is surrounded by an edge area RB free of hidden component structures (especially internal electrodes). The edge area RB is separated, in the processing step shown in FIG. 2e, from terminally positioned component areas B1 and BN by the intermediate spaces 6′ to be filled with metal paste, wherein the arrangement of component areas and the edge area is maintained on the carrier 7. The edge areas RS are separated in the step shown in FIG. 2h along the intermediate spaces from the terminally positioned component areas B1, BN.

### LIST OF REFERENCE SYMBOLS

10 Base body
10′ Multiple-layer body
100 First terminally positioned dielectric layer
101 Second terminally positioned dielectric layer
102 Capacitor stack
110 Layer sequence of dielectric layers and metal layers
1, 2 First or second internal electrode
1′, 2′ Terminally positioned first or second internal electrode
11, 12 First and second external electrode
11-j, 12-j First and second external electrode, j=1, 2, 3
21, 22 First and second contact surface
21-j, 22-j First and second contact surface, j=1, 2, 3
201, 202 Electrically conductive layer, which has a contact surface
28, 29 Electrical connection between an external electrode and a contact surface arranged on a main surface of the base body
31, 32 Through-hole contact
41, 42 Bumps
50, 51, 52 Insulating layer
6 Intermediate space formed between component areas
6′ Intermediate space formed between the edge area of the multiple-layer body 10′ and component areas
61 Electrically conductive material for filling the intermediate spaces 6, 6′
7 Carrier
B1, B2, B3 Component areas
RB Edge area

1. An electrical multiple-layer component, comprising:
a base body comprising:
dielectric layers, and
internal electrodes of a first type electrically connected to each other between the dielectric layers via at least one external electrode on a side surface of the base body, and
an electrical connection between the at least one external electrode and a contact surface arranged on a main surface of the base body and insulated relative to an outer side of the component.

2. The multiple-layer component of claim 1, wherein the electrical connection is in an interior of the base body.

3. The multiple-layer component of claim 1, wherein at least one of the internal electrodes is contacted with the contact surface via a through-hole contact.

4. The multiple-layer component of claim 1, wherein the at least one external electrode is electrically connected to an electrically conductive layer including the contact surface, and
wherein a part of the electrically conductive layer between the contact surface and the at least one external electrode is covered by an insulating layer.

5. An electrical multiple-layer component, comprising:
a base body comprising:
dielectric-layers,
a plurality of internal electrodes between the dielectric layers; at least some of the plurality of internal electrodes being electrically connected via a first external electrode on a first side surface of the base body, and at least some other ones of the plurality of internal electrodes being electrically connected via a second external electrode on a second side surface of the base body, and
wherein at least one of the internal electrodes is connected with at least one of a first and a second contact surface of the base body via a through-hole contact.

6. The multiple-layer component of claim 5, wherein the first contact surface is on a bottom side of the base body.

7. The multiple-layer component of claim 5, wherein an electrical connection between one of the first and second contact surface and at least one of the external electrodes associated with the contact surface is covered with an insulating layer relative to a surface of the component.

8. The multiple-layer component of claim 5, wherein the internal electrodes comprise a first set of internal electrodes and a second set of internal electrodes alternately one above the other, the first set of internal electrodes electrically connected to the first external electrode and the second set of internal electrodes electrically connected to the second external electrode.

9. The multiple-layer component of claim 8, wherein the internal electrodes comprise a first terminally positioned internal electrode and a second terminally positioned internal electrode in a plane; the first terminally positioned electrode in electrical contact with the first contact surface via a first through-hole contact; and the second terminally positioned electrode in electrical contact with the second contact surface via a second through-hole contact.

10. The multiple-layer component of claim 9, wherein the second terminally positioned internal electrode and the electrodes in the second set of internal electrodes are electrically connected to the second external electrode.

11. The multiple-layer component of claim 5, wherein the internal electrodes and the dielectric layers form a capacitor stack.

12. The multiple-layer component of claim 11, wherein the base body comprises a plurality of capacitor stacks one next to the other,
wherein the capacitor stacks are contacted by different contact surfaces.

13. The multiple-layer component of claim 11, wherein:
the base body has a first terminally positioned dielectric layer having a thickness greater than a thickness of the dielectric layers of the capacitor stack, and
the through-hole contact extends through the first terminally positioned dielectric layer.

14. The multiple-layer component of claim 13, wherein the first terminally positioned dielectric layer comprises a plurality of sublayers one above the other.

15. The multiple-layer component of claim 11, wherein the base body comprises a second terminally positioned dielectric layer facing away from the first terminally positioned dielectric layer and having a thickness greater than a thickness of the dielectric layers of the capacitor stack.

16. The multiple-layer component of claim 15, wherein the second terminally positioned dielectric layer comprises a plurality of sublayers one above the other.

17. The multiple-layer component claim 5, wherein the dielectric layers comprise a ceramic material.

18. The multiple-layer component of claim 5, wherein the contact surfaces are printed with Ball-Grid Array bumps.

19. The multiple-layer component of claim 5, wherein the contact surfaces are printed with Land-Grid Array bumps.

20. An electrical multiple-layer component, comprising:
a base body comprising
dielectric layers, and
a plurality of internal electrodes arranged between the dielectric layers; at least some of the plurality of internal electrodes being electrically connected to each other via a first external electrode on a side surface of the base body, and at least some of the plurality of internal electrodes being electrically connected to each other via a-second external electrode on a second side surface of the base body;
a first terminally positioned internal electrode connected to the first external electrodes, and
a second terminally positioned internal electrode connected to the second external electrode; the first and the second terminally positioned internal electrodes being formed in a plane and in electrical contact with a contact surface of the component via a through-hole contact.

21. A method for producing a multiple-layer component, comprising:
creating a first terminally positioned dielectric layer including electrical through-hole contacts,
creating electrically conductive layers contacting the through-hole contacts on both sides of the first terminally positioned dielectric layer,
creating a multiple-layer body comprising a plurality of component areas by forming a layer sequence comprising dielectric layers and metal layers one above the other on the first terminally positioned dielectric layers,
separating the plurality of component areas to form individual components, and
metallizing side surfaces of a particular component of the individual components to form external electrodes of the particular component.

22. A method for producing a multiple-layer component, comprising:
creating a first terminally positioned dielectric layer including electrical through-hole contacts,
creating electrically conductive layers contacting the through-hole contacts on both sides of the first terminally positioned dielectric layer,
creating a multiple-layer body comprising a plurality of component areas, the multiple-layered body comprising a layer sequence comprising dielectric layers and metal layers one above the other on the first terminally positioned dielectric layer,
applying the multiple-layer body to a carrier and separating the component areas,
filling intermediate spaces between adjacent ones of the component areas with an electrically conductive material, and
separating the component areas along the intermediate spaces to form the component.

23. The method of claim 22, further comprising maintaining the arrangement of the component areas on the carrier when applying the multiple-layer body to the carrier and separating the component areas.

24. The method of claim 22, further comprising arranging the electrically conductive layers on an exposed surface of the first terminally positioned dielectric layer, wherein the electrically conductive layers are printed with bumps before separating the component areas along the intermediate spaces.

25. The method of claim 24, wherein the electrically conductive layers form contact surfaces.

26. The method of claim 24, further comprising galvanically thickening the electrically conductive layers.

27. The method claim 25, further comprising depositing an insulating layer on a part of the electrically conductive layer,
wherein an area of the electrically conductive layer comprises the contact surfaces that are electrically connected with an external electrode.

28. The method of claim 22, wherein the multiple-layer body comprises a second terminally positioned dielectric layer facing away from the first terminally positioned dielectric layer and formed from a plurality of sublayers one above the other.

29. The method of claim 22, further comprising forming the first terminally positioned dielectric layer from a plurality of sublayers one above the other.

30. The method of claim 22, wherein a part of the multiple-layer body is surrounded by an edge area free from hidden component structures and separated after creating the multiple-layer body from the component areas by filling the intermediate spaces with the electrically conductive material, the edge area being separated along the intermediate spaces from the component areas,
wherein the arrangement of component areas and the edge area on the carrier is maintained.

31. The method of claim 21, further comprising creating the multiple-layer body by pressing, decarbonization, and sintering of a body comprising the terminally positioned dielectric layer and the layer sequence.

32. The multiple-layer component of claim 1, wherein at least one external electrode extends beyond an edge of the base body and forms a conductive layer, wherein the conductive layer includes the contact surface and is covered by a passivation layer other than the contact surface.

33. The method of claim 21, further comprising preparing the first terminally positioned dielectric layer with the through-hole contacts and the metal layers on two surfaces,
wherein the layer sequence is connected to the first terminally positioned dielectric layer.
